(19) United States
(12) Patent Application Publication
(10) Pub. No.: US 2004/0193472 A1
(43) Pub. Date: Sep. 30, 2004

(54) Systems, methods and computer program products for generating at least one shift schedule

(75) Inventors: Vishwamitra S. Ramakrishnan, Cambridge, MA (US); Stacy M. Dugan, Grapevine, TX (US); Puneet Kohli, Arlington, TX (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Sabre Inc., Southlake, TX

(21) Appl. No.: 10/395,640

(22) Filed: Mar. 24, 2003

(51) Int. Cl. G06F 17/60

(52) U.S. Cl. 705/9

(57) ABSTRACT

Systems, methods and computer program products are provided for generating at least one shift schedule. A method of generating at least one shift schedule includes receiving scheduling data. Then, a plurality of candidate shift schedules can be generated based upon the scheduling data. Thereafter, an optimum set of shift schedules can be selected based upon the plurality of candidate shift schedules and a quantitative measure of quality associated with the optimum set of shift schedules. The quantitative measure of quality is based upon a threshold cost and a cost associated with the optimum set of shift schedules. The method can also include processing the candidate shift schedules in accordance with one or more business rules. In such instances, the optimum set of shift schedules can be selected based upon the processed candidate shift schedules and the quantitative measure of quality.

### FIELD OF THE INVENTION

The present invention generally relates to scheduling systems and, more particularly, relates to systems, methods and computer program products for generating at least one shift schedule that includes a quantitative measure of quality.

### BACKGROUND OF THE INVENTION

In many industries today, such as the airline industry, organizations must continuously determine a schedule according to which workers of the respective organizations will perform assigned tasks over a planning period. As known to those skilled in the art, the workforce scheduling problem generally involves optimally matching available labor resources to the needs of an organization, with all applicable constraints to such matching taken into consideration. As will be appreciated, workforce planning for many large organizations can be a difficult, complex planning and control process.

In workforce planning, several requirements must be considered depending upon the particular conditions and policies of the respective organization. For example, an organization may be required to consider the nature of demand for workers, such as whether the demand for workers for operation of the organization is constant or varies over a given time period. Also, for example, an organization may be required to consider work rules, such as those relating to the use of part-time workers versus full-time workers. In addition, an organization may be required to consider the number and pattern of daily shifts, generally defined as the work schedules of workers for a specific day. In this regard, an organization may consider breaking up the day into multiple shifts (e.g., day, evening and/or night shifts) with alternative start-end times, and may also consider including break periods, such as for meals (e.g., lunch).

Accounting for all of the constraints or requirements placed on an organization, the object of workforce planning is to find a feasible schedule at a minimum cost. Workforce planning can generally be broken down by the length of the planning period, typically because different planning periods may have different constraints. In this regard, an organization can develop shift schedules defining the working starting and stopping times for each worker over a single working day. Additionally, or alternatively, an organization can develop shift schedules defining the working and nonworking days for each worker over a multiple working day period, such as a workweek. In other terms, then, an organization can develop shift schedules that, in addition to defining the working and nonworking days for each worker over multiple working days, define the working starting and stopping times for each worker over each of the planned working days.

As indicated above, shift scheduling generally involves developing a work schedule for a given planning period. In this regard, organizations must generally perform shift scheduling when it is necessary for the organization to determine which work schedule, or shift, each worker of the organization will be assigned each working day over the planning period, particularly when the shifts of multiple workers overlap over the day.

Conventionally, shift scheduling has been accomplished according to a number of different techniques. For example, many systems perform shift scheduling according to a heuristic technique whereby shift schedules are generated by sophisticated trial-and-error methods. Whereas conventional heuristic techniques are adequate to generate shift schedules, such techniques have drawbacks. In this regard, heuristic scheduling techniques do not typically provide control over the quality of the generated shift schedules. In fact, in some instances, it has been found that the shift schedules generated by the heuristic technique can be improved by manually altering the generated shift schedule. Also, heuristic techniques can, at times, exhibit a counter-intuitive behavior. For example, the shift schedules generated by the heuristic technique after adding one or more new constraints (such as a limit on the number of part-time workers) may be better than the shift schedules found before the constraints were added; this is counter-intuitive since placing more restrictions on the heuristic should not lead to better performance.

### SUMMARY OF THE INVENTION

In light of the foregoing background, embodiments of the present invention provide improved systems, methods and computer program products for generating at least one shift schedule. Embodiments of the present invention are capable of generating at least one, and more typically, an optimum set of shift schedules based upon a quantitative measure of quality. By selecting the set of optimum shift schedules based upon the quantitative measure of quality, embodiments of the present invention facilitate selecting an optimum set of schedules that has a desired level of quality. Further, embodiments of the present invention are capable of repeatedly selecting different sets of shift schedules until a set of shift schedules is found that has the desired level of quality. As will be appreciated, the higher number of sets of schedules that are selected, the higher the probability of selecting a set of schedules having a high level of quality. As such, embodiments of the present invention facilitate control over the quality of the optimum set of shift schedules and the processing time required to select the optimum set of shift schedules. In this regard, by decreasing the desired level of quality, the time required to select the optimum set of shift schedules can be similarly decreased. Alternatively, by increasing the time required to select the optimum set of shift schedules, the desired level of quality can be increased.

According to one aspect of the present invention, a method is provided for generating at least one shift schedule. Typically, the method begins by receiving scheduling data. Then, a plurality of candidate shift schedules can be generated based upon the scheduling data. Thereafter, an optimum set of shift schedules can be selected based upon the plurality of candidate shift schedules and a quantitative measure of quality associated with the optimum set of shift schedules. The quantitative measure of quality is based upon a threshold cost and a cost associated with the optimum set of shift schedules. The method can also include determining a threshold cost based upon the plurality of candidate shift schedules. In this regard, the threshold cost can comprise a minimum cost associated with any set of candidate shift schedules capable of being selected in accordance with the scheduling data, where the threshold cost comprises a lower bound cost associated with the selected optimum set of shift schedules.

More particularly, the optimum set of shift schedules can be selected such that the optimum set of shift schedules has an associated cost within a predefined acceptable variation from the threshold cost. To so select the optimum set of shift schedules, a set of shift schedules can be selected in accordance with the scheduling data. Then, a cost associated with the set of shift schedules can be compared to the threshold cost. Sets of shift schedules can be repeatedly selected, and thereafter repeatedly compared to the threshold cost, until an optimum set of shift schedules is selected that has an associated cost within a predefined acceptable variation from the threshold cost.

In various embodiments, the method can include processing the plurality of candidate shift schedules in accordance with at least one business rule before selecting the optimum set of shift schedules. As such, the optimum set of shift schedules can be selected based upon the processed plurality of candidate shift schedules and the quantitative measure of quality. As will be appreciated, the candidate shift schedules can be processed according to any of a number of different business rules. For example, the candidate shift schedules can be processed in accordance with a back-to-back rule to identify any groups of part-time schedules that have an equivalent full-time schedule. Then, the optimum set of shift schedules can be selected such that the set does not include those groups of part-time schedules that have an equivalent full-time schedule.

Also, for example, the candidate shift schedules can be processed in accordance with a maximum starts constraint to thereby select a plurality of schedules with valid starts such that the plurality of schedules with valid starts include at least one non-integer schedule, and such that each schedule with valid starts has a number of shift start times not exceeding a maximum number of start times. In such an instance, the optimum set of shift schedules can be selected based upon the plurality of schedules with valid starts and the quantitative measure of quality. Before selecting the optimum set of schedules, however, the schedules with valid starts can be further processed by select a plurality of efficient candidate schedules and thereafter finding a plurality of integer schedules. Then, the optimum set of shift schedules can be selected based upon the plurality of integer shift schedules and the quantitative measure of quality.

The candidate shift schedules can also be processed, for example, in accordance with the scheduling data to select a plurality of intermediate shift schedules that includes at least one non-integer schedule. In such an instance, the optimum set of shift schedules can be selected based upon the plurality of intermediate shift schedules and the quantitative measure of quality. Before selecting the optimum set of schedules, the intermediate shift schedules can be further processed by select a plurality of efficient candidate schedules and thereafter finding a plurality of integer schedules. Then, like before, the optimum set of shift schedules can be selected based upon the plurality of integer shift schedules and the quantitative measure of quality.

By way of further example, the candidate shift schedules can be processed to incorporate at least one lunch into the plurality of candidate shift schedules when the scheduling data defines at least one lunch. Then, the optimum set of shift schedules can be selected based upon the plurality of candidate shift schedules including the incorporated lunches and the quantitative measure of quality. In instances in which the candidate shift schedules are processed by selecting a plurality of intermediate shift schedules, and the shift schedules are not subject to a maximum starts constraint, the candidate shift schedules can be processed to select the intermediate shift schedules before processing the plurality of candidate shift schedules to incorporate the lunches. In instances in which the shift schedules are subject to a maximum starts constraint, then, the plurality of candidate shift schedules can be processed in accordance with the maximum starts constraint to thereby select a plurality of schedules with valid starts, and thereafter the plurality of candidate shift schedules can be processed to incorporate the lunches.

Also, in instances in which the candidate schedules are processed to incorporate lunches, a plurality of flexible candidate schedules can be selected based upon the extent of flexibility of the schedule to the insertion of at least one lunch. Thereafter, the flexible candidate shift schedules can be processed to incorporate at least one lunch.

According to other aspects of the present invention, a system and computer program product are provided for generating at least one shift schedule. Therefore, embodiments of the present invention provide improved systems, methods and computer program products for generating at least one shift schedule. Embodiments of the present invention are capable of generating at least one, and more typically, an optimum set of shift schedules based upon a quantitative measure of quality to thereby facilitate selecting an optimum set of schedules that has a desired level of quality. In this regard, embodiments of the present invention are capable of repeatedly selecting different sets of shift schedules until a set of shift schedules is found that has the desired level of quality, thereby providing increased control over the quality of the optimum set of shift schedules and the processing time required to select the optimum set of shift schedules. As such, the systems, methods and computer program products of the present invention solve the problems identified by prior techniques and provide additional advantages.

### BRIEF DESCRIPTION OF THE DRAWINGS

Having thus described the invention in general terms, reference will now be made to the accompanying drawings, which are not necessarily drawn to scale, and wherein:

FIG. 1 is a flowchart illustrating various steps in a method of generating at least one shift schedule according to one embodiment of the present invention;

FIG. 2 is a more detailed flowchart of a method of generating at least one shift schedule according to one embodiment of the present invention; and

FIG. 3 is a schematic block diagram of a system for generating at least one shift schedule according to one embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

According to one aspect of the present invention, a method is provided for generating at least one shift schedule. As used herein, a shift schedule comprises a schedule for a worker over a planning period. The shift schedule may contain one or more shifts for the worker, and may cover a planning period of a day or more with any off days included. For example, one shift schedule may comprise the following: Sunday 9 am-5 pm; Monday 9 am-5 pm; Tuesday off; Wednesday 8 am - 4 pm; Thursday off; Friday 2 pm-8 pm; and Saturday 2 pm-8 pm. As will be appreciated, then, whereas the method of embodiments of the present invention can generate at least one shift schedule, the method typically generates a set of shift schedules including the number of shift schedules required for a given number of workers, and/or to meet a given workload.

As will be appreciated by those skilled in the art, in its most basic form the workforce scheduling problem can be formulated as a single integer programming model. As various business rules or constraints are added to the workforce scheduling problem, however, it becomes difficult to capture all the complexity within a single integer programming model. As such, the method of embodiments of the present invention can advantageously generate at least one shift schedule while incorporating one or more optional processes, each accomplishing one or more specific tasks.

As described in more detail below, the method generally begins by receiving scheduling data, including data such as permissible shift types, permissible days on—days off patterns and/or staffing requirements information (e.g., workload and/or number of workers). For example, the scheduling data may indicate the number of workers that are required Monday through Friday in five minute intervals during hours of 9 am-12 pm and 1 pm-4 pm. The scheduling data may also indicate, for example, that only six-hour and eight-hour shifts may be used, and/or that shift schedules must have at least one day off in the five day period from Monday to Friday. Next, a plurality of candidate schedules are generated based upon the scheduling data. The candidate schedules can then be processed by applying one or more business rules or constraints to generate at least one, and more typically a plurality of, shift schedules. As will be appreciated, generating the shift schedules can include processing millions, if not billions, of different shift schedules.

As used herein, an optimum (i.e., selected) set of shift schedules comprise a set of schedules that satisfy all of the business rules and constraints, and is also associated with a low cost and a high efficiency when compared against other sets of shift schedules. It should be understood, however, that the optimum set of shift schedules is not necessarily the best set of shift schedules that satisfy all of the business rules and constraints, and is associated with the lowest cost and/or highest efficiency. In this regard, as explained more fully below, the optimum set of shift schedules can comprise a set of shift schedules that has at least a predefined acceptable variation from a threshold cost.

Although the cost of a shift schedule can be defined in any of a number of different manners, both monetarily and otherwise, a typical example of a “cost” is full-time equivalent (“FTE”) cost. In this regard, an FTE cost can be defined as the cost of a schedule based on full time workers. For example, if a schedule defines a full-time worker as someone that works eight hours per day, a part-time worker who works four hours per day would be a considered 0.5 FTE worker. Advantageously, embodiments of the present invention are capable of providing a quantitative guarantee of the quality of the optimum set of shift schedules by relating the cost of the selected set of shift schedules to a lower bound of the least costly set of shift schedules, referred to herein as a threshold cost.

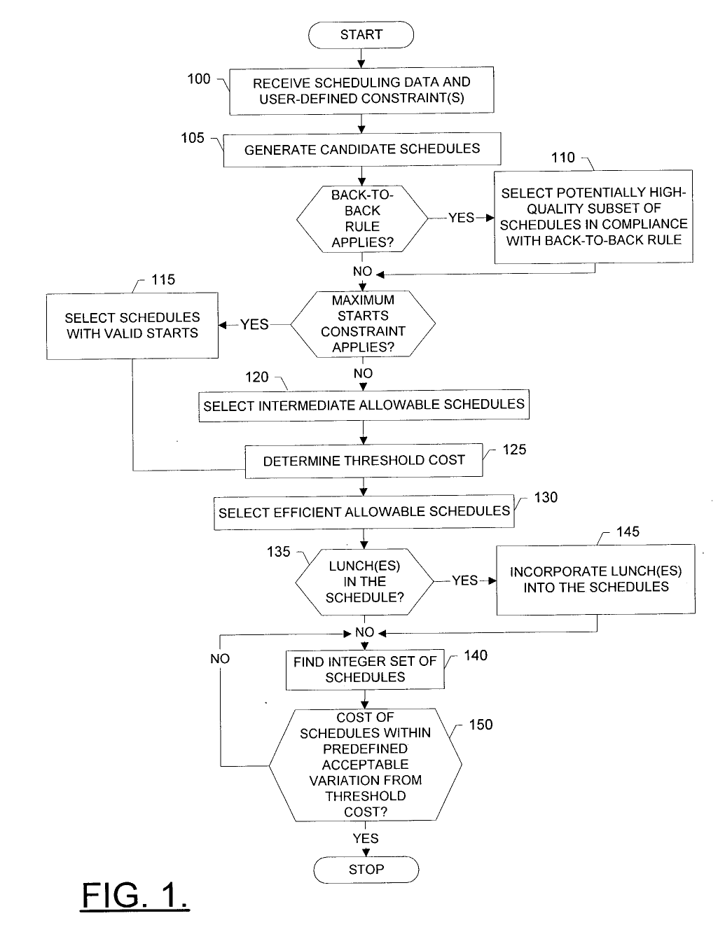

Reference is now drawn to FIG. 1, which illustrates a flow chart of a method of determining at least one shift schedule according to one embodiment of the present invention. As indicated above and shown at stage 100, the method typically begins by receiving scheduling data, which can include one or more user-defined constraints, if so desired. The scheduling data can also include any of a number of different types of information known to those skilled in the art, such as shift types, schedules and/or staffing requirements information. For example, the scheduling data may indicate the number of workers that are required Sunday through Saturday in five-minute intervals, where each five-minute interval is referred to as a requirement interval. It should be understood, however, that a requirement interval need not be five minutes, but can be longer or shorter than five minutes without departing from the spirit and scope of the present invention. The data may further indicate that only six-hour and eight-hour shifts may be used, and/or that shift starting times can be any multiple of fifteen minutes. Similarly, user-defined constraints can include any of a number of constraints to which a shift schedule may be subject. For example, it may be specified that every shift schedule must have five consecutive work days and two consecutive off days in any one week period. Another user-defined constraint may specify that no part-time schedules (i.e., schedules for part-time workers) be generated. Alternatively, for example, a user-defined constraint may specify that no full-time schedules be generated (i.e., schedules for full-time workers).

After receiving the scheduling data and any user-defined constraints, the method continues by generating a plurality of “candidate schedules” based on the scheduling data, as shown at stage 105. The candidate schedules can be generated in any of a number of different manners, as are well known to those skilled in the art. For example, the candidate schedules can be generated to consist of schedules for all possible start times (based upon the shift start interval) and day on/off patterns. To continue the example from above, the candidate schedules can be created by first generating all possible shifts that start every fifteen minutes and are either six or eight hours, for a total of 192 possible shifts (i.e., 24 hours/day×4 shifts/hour×2 shift types). Then, all possible 5 working days-2 off day patterns can be generated from the total possible shifts (e.g., work 9 am-3 pm Monday-Friday, take Saturday-Sunday off). In instances including user-defined constraints, the candidate schedules are generated further based upon the user-defined constraints. For example, in instances in which a user-define constraint forbids the inclusion of part-time schedules, no part-time candidate schedules will be generated.

In addition to generating the candidate schedules based upon the scheduling data and user-defined constraints, the candidate schedules can advantageously be generated to further spread the demand for workers evenly across a schedule by examining the intervals in the scheduling data at which there are high demands for workers. For example, presume that a five workers are required between the hours of 9 am-12 pm, seven workers are required between 12-1 pm, and three workers are required between 1 pm-2 pm. In such an instance, it would be advantageous to “cut” the demand between 12 pm-1 pm by two workers and “assign” those workers to the 1 pm-2 pm time interval. Moving the workers would then result in an even demand for five workers throughout all time periods, rather than requiring seven workers to meet the peak demand who would then be idle the rest of the time.

After generating the candidate schedules, the candidate schedules can be processed by imposing one or more further constraints, or business rules, on the candidate schedules. For example, the candidate schedules can be processed according to a back-to-back rule to select, from those schedules affected by the back-to-back rule, a potentially-high quality set of part-time schedules that do not have an equivalent full-time schedule, as shown at stage 110 and described below. In addition to, or in lieu of, applying the back-to-back rule, a maximum-starts constraint can be placed on the candidate schedules that imposes a maximum on the number of start times possible within a schedule.

If the maximum-starts constraint exists, then those candidate schedules having a number of start times not exceeding the maximum number of start times, and thus satisfying the maximum-starts constraint, are selected as schedules with valid starts, as shown at stage 115. If the candidate schedules are not subject to the maximum-starts constraint, an intermediate set of allowable schedules are selected from the candidate schedules, as shown at stage 120. Although the scheduling data may require one or more breaks in a given schedule, such as for meals (e.g., lunch), appointments (e.g., doctor appointments), the intermediate allowable schedules and schedules with valid starts are determined without regard to such breaks, which will be accounted for later and may herein collectively be referred to as a “lunch.” In addition, the intermediate allowable schedules may include fractional, or non-integer, schedules, as described below.

At stage 125, a threshold cost is determined from the schedules with valid start times (see stage 115) or the intermediate allowable schedules (see stage 120), collectively referred to as the remaining candidate schedules. The threshold cost can be any cost associated with a set of shift schedules that satisfy the scheduling data, as well as the previously processed business rules and user-defined constraints. According to one advantageous embodiment, however, the threshold cost can be determined from the remaining candidate schedules as the smallest FTE cost associated with any set of candidate schedules that satisfy the scheduling data, as well as the previously processed business rules and user-defined constraints. As the set of candidate schedules having the smallest FTE cost may not satisfy subsequently applied business rules or constraints, the smallest cost may not equal the cost of the optimum set of schedules, as described below. Also, as will be appreciated to those skilled in the art, applying business rules or constraints to the remaining candidate schedules typically increases the cost of such schedules so that the remaining schedules after applying the business rules and constraints typically have a higher cost than the remaining schedules before applying the business rules. Therefore, the smallest cost associated with any set of schedules selected from either the schedules with valid start times or the intermediate allowable schedules actually represents a lower bound of the cost associated with the least costly set of candidate schedules that satisfies all of the subsequently applied business rules and constraints. In other terms, the least costly set of schedules after applying subsequent business rules and constraints can have any of a number of different costs that are all greater than or equal to the threshold cost.

While the set of schedules selected in stage 120 (or stage 115 if starts constraints are present) is guaranteed to be optimal in terms of solution cost, the selected set of schedules may not be the best in terms of other desirable attributes such as shift efficiency, as described below. As such, after determining the threshold cost at stage 125, this notion of schedule efficiency is used in stage 130 to select a set of schedules from the set of cost-optimal schedules such that the selected set has a high a shift efficiency, when compared to the remaining schedules.

At stage 135 it is determined whether the remaining candidate schedules contain at least one lunch. If the remaining candidate schedules are not subject to at least one lunch, the remaining candidate schedules are processed to find integer schedules, as shown at stage 140. If the remaining candidate schedules are subject to at least one lunch, however, the remaining candidate schedules are processed to incorporate the required lunches, as shown at stage 145. Once the lunches have been incorporated into the schedules, schedules including lunches can be processed, like before, to generate at least one integer schedule, as shown at stage 140.

At stage 150, after the set of integer schedules has been selected, a cost associated with the set of integer schedules can be compared against the threshold cost (see stage 125). In this regard, by relating the cost associated with the set of integer schedules with the threshold cost, a quantitative guarantee of the quality of the set of integer schedules can be generated. The cost associated with the set of integer schedules can be compared to the threshold cost in this manner. If the set of integer schedules is within a predefined acceptable variation from the threshold cost, the set of integer schedules can be selected as the final, optimum set of schedules. If the integer schedules are not within the predefined acceptable variation from the threshold cost, however, the method can be repeated by selecting another set of integer schedules at stage 135. Thereafter, the cost associated with the new set of integer schedules can be compared to the threshold cost. In this regard, the method repeats with a new set of generated integer schedules until an integer set of schedules is generated that has an associated cost within the predefined acceptable variation from the threshold cost.

As an example, presume that at stage 125 a threshold cost was determined to equal $100. Then, presume that the predefined acceptable variation from the threshold cost was set at 10% of the threshold cost. At stages 140 and 150, then, the method will repeatedly generate sets of integer schedules until a set of schedules is generated that has a cost less than or equal to $110 (i.e., $100×0.10). In other terms, presume that the integer set of schedules has an associated cost within 10% of the threshold cost of $100. By selecting the integer set of schedules as such, the optimum set of schedules can be considered to have a quantitative guarantee to have a cost within 10% of the least costly schedule (i.e., least costly schedule after all business rules and constraints are applied). Advantageously, by determining the lower bound of the least costly schedule, the quantitative guarantee of quality can be determined and associated with the optimum set of integer schedules without actually determining the least costly schedule from among all of the possible sets of schedules.

As will be appreciated, the higher number of sets of schedules that are selected in order to find or select the optimum set of schedules, the higher the probability of selecting a set of schedules having a high level of quality. As such, by selecting a predefined acceptable variation from the threshold cost with which to compare the cost of the selected set of schedules, the method facilitates control over the quality of the optimum set of shift schedules and the processing time required to select the optimum set of shift schedules. In this regard, by increasing the predefined acceptable variation (thereby decreasing the desired level of quality of the optimum set of schedules), the time required to select the optimum set of shift schedules can be similarly decreased. Alternatively, by increasing the time required to select the optimum set of shift schedules, the predefined acceptable variation can be decreased thereby increasing the desired level of quality.

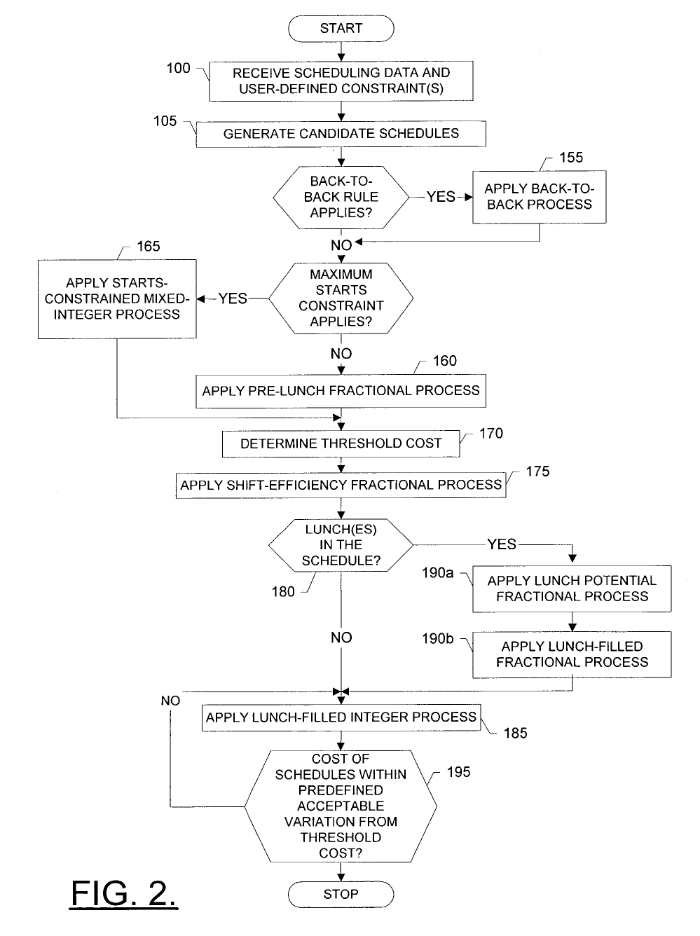

Reference is now made to FIG. 2, which illustrates in more detail various steps in the method of generating at least one shift schedule according to the embodiment of FIG. 1. As before, at stages 100 and 105, the method preprocesses scheduling data, and generates candidate schedules based on the scheduling data and a number of user-defined constraints (if desired). As will be appreciated, though, the user-defined constraints and business rules can be implemented at various stages throughout the method. In this regard, some user-defined constraints and/or business rules are simple and may be handled at the preprocessing stage. As discussed above, the user-defined constraint disallowing all part-time schedules may be accounted for in generating the candidate schedules. Other, more complex user-defined constraints and/or business rules, however, are typically accounted for at various stages throughout the process, such as the back-to-back rule, maximum-starts constraints and/or lunch business rules.

With the candidate schedules, the method next determines whether the back-to-back rule may be applied. As indicated above, the back-to-back rule prevents the use of multiple part-time schedules (i.e., schedules for part-time workers) where equivalent full-time schedules (i.e., schedules for full-time workers) could be generated. More particularly, in applying the back-to-back rule at stage 155, the part-time candidate schedules are first examined to determine which schedules are affected by the back-to-back rule. In this regard, a part-time candidate schedule is considered affected by the back-to-back rule if the duration of any part-time shift within the candidate schedule plus the duration of any other part-time shift within any other candidate schedule (including the part-time shift of the same part-time candidate schedule) fits within a back-to-back part-time shift window that has been reduced by a minimum overlap period. In this regard, the back-to-back part-time shift window sets forth the length of time within which no two non-overlapping part-time shifts may be fully contained. The minimum overlap period, then, is defined as the minimum duration during which part-time shifts can overlap. For example, the back-to-back part-time shift window can be set to equal a duration of eight hours (the number of hours in a typical full-time shift), and the minimum overlap period can be defined to equal zero. In this case, the back-to-back rule states that no two or more part-time schedules in the optimum set of schedules can be fully contained in any eight-hour window.

To process the back-to-back affected schedules, every pair of back-to-back affected candidate schedules is examined to see if the pair of schedules violates the back-to-back rule. If the candidate schedules in the pair do not overlap in time, the pair of candidate schedules violates the back-to-back rule when the durations of the respective schedules, plus the duration between the end time of the first (timewise) schedule in the pair and the start time of the second schedule, fits within the back-to-back part-time shift window (e.g., eight hours). Alternatively, if the candidate schedules in the pair do overlap in time, the pair of candidate schedules violates the back-to-back rule when (a) the total duration of the respective schedules fits within the back-to-back part-time shift window, and (b) the candidate schedules do not overlap by more than the minimum overlap period (e.g., 30 minutes).

If a pair of candidate schedules violates the back-to-back rule, for each set of candidate schedules subsequently selected as the optimum set of schedules, no more than one of the candidate schedules in the pair can be present. As an example of determining the back-to-back affected schedules and then examining those schedules to find pairs of schedules that violate the back-to-back rule, presume four candidate schedules contain the following shifts on the same day: (a) 8 am-12 pm, (b) 12 pm-4 pm, (c) 3 pm-7 pm, and (d) 8 am-6 pm. In such an instance, schedule (d) is not affected by the back-to-back rule as schedule (d) has a duration of eight hours and, as such, no other schedule (part-time or full-time) duration could be added to the duration of schedule (d) such that the sum fits within the back-to-back part-time shift window. By examining the back-to-back affected schedules, then, it can be shown that the pair of schedules (a) and (b) violate the back-to-back rule as schedules (a) and (b) do not overlap, and the total duration of schedules (a) and (b) is eight hours, which fits within the back-to-back part-time shift window of eight hours. Schedules (a) and (c) do not violate the back-to-back rule because the total duration of the respective schedules and the duration between the schedules equals eleven hours, respectively. Also, schedules (b) and (c) do not violate the back-to-back rule because, although schedules (b) and (c) fit within the back-to-back part-time shift window, schedules (b) and (c) overlap by one hour, which is more than the minimum overlap period of 30 minutes.

As indicated above, the back-to-back affected candidate schedules are processed to select a set of the most efficient schedules that does not include any two schedules that violate the back-to-back rule (i.e., two part-time schedules that could have a full-time equivalent schedule). In this regard, the efficiency of a schedule can be defined as the fraction of a schedule's duration that has non-zero work requirements. For example, if a schedule lasts from 11 am-4 pm, and the time interval between 2-4 pm includes no work requirements, the schedule can be considered to be 60% efficient (i.e., 3 hrs/5 hrs). By being able to associate an efficiency with each schedule, the set of candidate schedules that have the highest total efficiency and that satisfy the back-to-back rule may be selected. While any number of schedules can be selected according to the back-to-back rule, the number of schedules selected is typically the maximum number of possible schedules such that adding one more schedule to the set will result in a violation of the back-to-back rule.

Written in mathematical terms, then, the back-to-back rule can be represented as follows:

$$Max {Z}_{B2B} = {\sum }_{j = 1}^{n} {e}_{j} {x}_{j} \qquad Maximize efficiency$$

Maximize efficiency subject to:

xⱼ+xⱼ′≦1∀j,j′∈B

Forbidden Schedule Pair Constraints

If the candidate schedules do not contain any full-time schedules, but only part-time schedules, the back-to-back rule is subject to a requirement coverage constraint, which can be represented as follows:

$${\sum }_{j = 1}^{n} {a}_{ij} {x}_{j} \geq {r}_{i} i = 1 … m$$

xⱼ∈[0,1]

Where:

Z_{B2B}=The sum of the efficiencies of all the back-to-back affected schedules selected according to the back-to-back rule;

eⱼ=The efficiency of scheduled; and

xⱼ=Indicator decision variable associated with each unique schedule j (xⱼ is assigned to equal 1 or 0 such that all of the constraints are satisfied and Z_{B2B} is maximized).

Given:

$$\begin{matrix}{a}_{ij} = \{ \begin{matrix}1 & 1 if schedule j is active during requirement interval i , \\ 0 & 0 otherwise ;\end{matrix} \\ {r}_{i} = \{ \begin{matrix}1 & if demand exists in at least one of the requirement \\ 0 & intervals ( e . g . , five minute intervals ) , i , across all days in the \\ & planning period , \\ & 0 otherwise ;\end{matrix}\end{matrix}$$

m=Number of requirement intervals;

n=Predetermined number of schedules selected according to the back-to-back rule; and

B=Set of all schedule pairs violating the back-to-back rule.

After the most efficient set of back-to-back affected schedules have been selected, all of the candidate schedules not affected by the back-to-back rule and the most efficient subset of schedules from the set of all back-to-back affected schedules are passed on as candidate schedules that satisfy the back-to-back rule.

As shown in FIG. 1, after applying the back-to-back rule to all back-to-back affected schedules, a determination can be made whether to apply maximum-starts constraints to the candidate schedules that satisfy the back-to-back rule. In this regard, the maximum-starts constraints can impose constraints on the number of distinct schedule start times that may occur within a given time interval. More particularly, the maximum-starts constraints can include constraints such as, for example, total maximum starts, full-time maximum starts and/or part-time maximum starts. The total maximum-starts constraint can define the total number of allowable schedules (full-time and part-time), whereas the full-time and part-time maximum-starts constraints apply to the number of allowable full-time and part-time schedules, respectively.

In addition to the different types of maximum-starts constraints, the maximum-starts constraints may be further defined by additional constraints, such as maximum start periods, maximum start values and/or maximum start remainders. The maximum start periods defines the time interval during which a maximum start constraint applies. The maximum start value constraint defines the number of distinct start schedules that may occur during a maximum start period. And the maximum start remainder constraint sets forth the number of distinct starts that may occur outside the time period defined by the maximum start period. For example, presume a schedule that has a maximum start period of 4 am-12 pm with a maximum start value of four. In such an instance, the maximum-starts constraint would not select more than four distinct schedule start times between the hours of 4 am and 12 pm. If a maximum start remainder constraint of five applied to the above exemplary, then the total number of distinct starts from the beginning of the day until 4 am, and from 12 pm until the end of the day, cannot exceed five.

If the candidate schedules are not subject to a maximum-starts constraint, the candidate schedules that satisfy the back-to-back rule can be subjected to a “Pre-Lunch Fractional” process that selects a set of schedules (intermediate allowable schedules) without regard to any maximum-starts constraints, as shown at stage 155. When the Pre-Lunch Fractional process has been applied to the candidate schedules that satisfy the back-to-back rule, an optimal set of schedules (least costly set of schedules) from the candidate schedules satisfying the back-to-back rule is selected.

Typically, there are numerous other sets of schedules that have the same cost as the optimal set. In other terms, numerous optimal sets of schedules typically exist. While the set of schedules selected according to the Pre-Lunch Fractional process is guaranteed to be optimal in terms of solution cost, the selected set of schedules may not be the best in terms of other desirable attributes, such as the time between the start of the first shift and the earliest time at which workers are required. For practical reasons, it is often preferred for shifts to not start too much earlier than the time at which workers are required. For example, if workers are required no earlier than 6 am, it is often preferred that shifts do not start at 3 am or 2 am even though the associated cost may be optimal.

The Pre-Lunch Fractional process seeks to find the best set of schedules that satisfy the business rules, user-defined constraints and input staffing requirements. In this regard, the Pre-Lunch Fractional process can produce a number of fractional sets of schedules that adhere to the constraints set forth by the user, such as shift protections including, for example, a maximum percentage of part-time schedules in the total number of schedules, a maximum percentage of part-time schedules to full-time schedules, boundaries (i.e., minimum and maximum numbers) in the total number of full-time schedules, and boundaries (i.e., minimum and maximum numbers) in the total number of part-time schedules. As used herein, a fractional set of schedules can be defined as a set of schedules that may contain fractional (non-integer) schedules. For example, a fractional roster may contain 5.7 schedules of type A and 7.3 schedules of type B.

The Pre-Lunch Fractional process can be represented in any of a number of different manners. In one embodiment, for example, the Pre-Lunch Fractional process can be represented notationally as follows:

$$Min {Z}_{Base} = {\sum }_{j = 1}^{n} {c}_{j} {y}_{j}$$

subject to the following requirement coverage:

$${\sum }_{j = 1}^{n} {a}_{ijk} {y}_{j} \geq {r}_{jk} i = 1 , 2 , … , m k = 1 , 2 , … , p$$

If a user-defined, shift protection constraint defines a maximum percentage of part-time schedules in the total number of schedules, then the Pre-Lunch Fractional process can apply the following additional constraint:

$$0 \leq {P\_Total}_{max} {\sum }_{j = 1}^{n} {y}_{j} - {\sum }_{j = 1}^{n} {P}_{j} {y}_{j}$$

Alternatively, if a user-defined, shift protection constraint defines the maximum percentage of part-time schedules to full-time schedules, the Pre-Lunch Fractional process can applying the following additional constraint:

$$0 \leq {P\_FT}_{max} {\sum }_{j = 1}^{n} {F}_{j} {y}_{j} - {\sum }_{i = 1}^{n} {P}_{j} {y}_{j} + C$$

Otherwise, if a user-defined, shift protection constraint defines boundaries (i.e., minimum and maximum numbers) in the total number of full-time schedules and demand requirement, the Pre-Lunch Fractional process can apply the following added constraint:

$${Min}_{FT} \leq {\sum }_{j = 1}^{n} {F}_{j} {y}_{j} \leq {Max}_{FT}$$

But if a shift protection constraint defines boundaries (i.e., minimum and maximum numbers) in the total number of part-time schedules and demand requirement, the Pre-Lunch Fractional process adds the constraint:

$${Min}_{PT} \leq {\sum }_{j = 1}^{n} {P}_{j} {y}_{j} \leq {Max}_{PT}$$

The number of times schedule j appears in the solution can also be limited by the following constraint:

0≦yⱼ≦uⱼj=1. . . n

In all instances, the various variables can be shown to represent the following:

Decision Variables:

yⱼ=Number of times scheduled appears in the set of schedules, e.g., y₁=3.2, y₂=1.9 (note that yⱼ can have a non-integer value as used in various processes described herein).

Given:

cⱼ=Cost, such as FTE-based cost, of scheduled j, e.g., c₁=1.5, c₂=0.5

$${a}_{ijk} = \{ \begin{matrix}1 & if schedule j cover interval i on day k , \\ 0 & otherwise ;\end{matrix}$$

uᵢₖ=Staffing requirements for interval i on day k, e.g., interval i=1, k=1, rᵢₖ=3 represents a requirement for three workers on the first interval (e.g., 0000-0005 hours) of day 1 (e.g., Sunday);

uⱼ=Upper bound on scheduled (computed as maximum requirement over the schedule's active intervals), e.g., u₁=33 represents a constraint that y₁ cannot exceed 33;

P_Totalₘₐₓ=Maximum percentage of the total number of schedules that may be part-time schedules, e.g., P_Totalₘₐₓ=35%;

P_FTₘₐₓ=Maximum percentage of the number of part-time schedules to the number of full-time schedules, e.g., P_FTₘₐₓ=10%;

C=User-defined constant, e.g., C=5 (represents a remainder over the total number of part-time schedules defined by P_FTₘₐₓ);

Min_{FT}=Minimum number of full-time schedules allowed, e.g., Min_{FT}=10;

Max_{FT}=Maximum number of full-time schedules allowed, e.g., Max_{FT}=100;

Min_{PT}=Minimum number of part-time schedules allowed;

Max_{PT}=Maximum number of part-time schedules allowed;

$$\begin{matrix}{P}_{i} = \{ \begin{matrix}1 & if schedule j is a part \text{-} time schedule , \\ 0 & otherwise ;\end{matrix} \\ {F}_{i} = \{ \begin{matrix}1 & if schedule j is a full time schedule , \\ 0 & otherwise ;\end{matrix}\end{matrix}$$

p=Number of days in planning period (e.g., seven);

n=Number of unique schedules; and

m=Number of requirement intervals, e.g., m=2016 (if the workweek is has a requirement interval of five minutes, m=12 five-minute intervals/hour×24 hours/day×7 days/week).

If the candidate schedules that satisfy the back-to-back rule are subject to maximum-starts constraints (see stage 120), instead of the Pre-Lunch Fractional process the schedules are subjected to a “Starts-Constrained Mixed-Integer” process at stage 165. The Starts-Constrained Mixed-Integer process contains constraints and a set of integer decision variables in order to impose the maximum-starts constraints. Generally, the Starts-Constrained Mixed-Integer process serves to minimize costs subject to using schedules that satisfy the maximum-starts constraints. Therefore, the Starts-Constrained Mixed-Integer process produces schedules that fit within the maximum-starts constraints.

The Starts-Constrained Mixed-Integer process can be considered an extension of the Pre-Lunch Fractional process that also subjects the candidate schedules to constraints that limit the number of starts. Written notationally, then, the Starts-Constrained Mixed-Integer process can be represented as the Pre-Lunch Fractional process (see above) with the following additional binding-starts-per-day constraints and binding-schedules-start constraints, respectively:

Z_{t,k}=z_{t,k-1}t=1. . . s, k=1. . . d

yⱼ≦Z_{t,k}uⱼ∀bⱼₜₖ=1,j=1 . . . n, t=1. . . s, k=1. . . d

The preceding constraint connects the decision variables yⱼ (representing the number of copies of scheduled in the optimum set of shift schedules) with the 0-1 decision variables z_{t,k} that represent allowed start times, as shown below. If the total number of maximum starts has been defined, the following constraint can also be added:

$${\sum }_{t , w} {z}_{t , k} \leq S {\_Max}_{Total , w} ∀ t ∈ {MSP}_{Total , w} k = 1 … d , w = 1 … p$$

Otherwise, if the maximum number of full-time shift starts has been defined, the Starts-Constrained Mixed-Integer process adds the following:

$${\sum }_{t , w} {z}_{t , k}^{′} \leq S {\_Max}_{FT , w} ∀ t ∈ {MSP}_{FT , w} k = 1 … d , w = 1 … p$$

However, if the maximum number of part-time shift starts has been defined, the following constraint is added:

$${\sum }_{t , w} {z}_{t , k}^{″} \leq S {\_Max}_{PT , w} ∀ t ∈ {MSP}_{PT , w} k = 1 … d , w = 1 … p$$

In the preceding, the decision variables are the following:

$${z}_{t , k} = \{ \begin{matrix}1 & If at least one schedule starts at time t on day k , \\ 0 & Otherwise .\end{matrix}$$

Given:

$${b}_{jtk} = \{ \begin{matrix}1 & If schedule j contains a shift covering day k , and \\ & the shift starts at time t , \\ 0 & Otherwise ;\end{matrix}$$

s=Number of possible schedule start times within a single day;

p=Number of maximum start periods;

MSP_{Total, w}=The set of total maximum start periods, w=1. . . p;

MSP_{FT,w}=The set of full-time maximum start periods, w=1. . . p; and

MSP_{PT,w}=The set of part-time maximum start periods, w=1. . . p.

As will be appreciated, Z_{t,k} can actually be represented as three different decision variables depending on the maximum start scenario. For example, if full-time and part-time maximum start periods exist, they can be modeled separately as z′ for the full-time schedules and z″ for the part-time schedules. For clarity, however, this distinction is not shown in the above.

At stage 170, after the candidate schedules are processed according to either the Pre-Lunch Fractional process or the starts-constrained mixed-integer process, a threshold cost can be determined from either the intermediate allowable schedules or the schedules with valid starts. As indicated above, in one embodiment, the threshold cost can be determined from the remaining candidate schedules as the smallest FTE cost associated with any set of candidate schedules that satisfy the scheduling data, as well as the previously processed business rules and user-defined constraints. As such, the threshold cost can be determined by calculating an FTE cost for every possible set of schedules from the remaining candidate schedules that satisfy the scheduling data, as well as the previously processed business rules and user-defined constraints, and thereafter selecting the smallest FTE cost.

The process as depicted in FIG. 2 continues at stage 175 with the “Shift-Efficiency Fractional” process. As well known to those skilled in the art, considerations such as efficiency add to the importance of the schedules selected according to embodiments of the present invention. A schedule's efficiency can be considered the fraction of the schedule's duration that has non-zero work requirements. As such, the Shift-Efficiency Fractional process uses this notion of schedule efficiency to refine the set of schedules to those that are not only optimal from a cost standpoint, but also an efficiency standpoint. Generally, the Shift-Efficiency Fractional process builds upon the Pre-Lunch Fractional process but also adds a new constraint that forces the Shift-Efficiency Fractional process to consider only those solutions that are optimal in the Pre-Lunch Fractional process. In this regard, the Shift-Efficiency Fractional process can sum the “efficiency” values of the schedules in a given set of schedules. Thus, the Shift-Efficiency Fractional process can find a set of schedules that maximizes the “efficiency” from amongst the set of optimal cost schedules found according to the Pre-Lunch Fractional process. This results in a solution that is not only cost optimal but also desirable from other perspectives, such as efficiency.

Like the other processes, the Shift-Efficiency Fractional process can be represented in any of a number of different manners. In one embodiment, for example, the Shift-Efficiency Fractional process can be represented notationally as follows:

$$Max {Z}_{SEF} = {\sum }_{j = 1}^{n} {e}_{j} {y}_{j}$$

subject to the constraints described above in conjunction with the Pre-Lunch Fractional process, as well as the following:

$${\sum }_{j = 1}^{n} {c}_{j} {y}_{j} \leq {Z}_{Base}$$

Where:

eⱼ=“Efficiency” of schedule j (as defined above); and

Z_{Base}=Objective value from the Pre-Lunch Fractional process.

The process depicted in FIG. 2 continues at stage 180, where it is determined if any of the remaining schedules contain a lunch break. If the set of schedules generated by the Shift-Efficiency Fractional process (stage 175) contain at least one lunch break, the schedules can be processed to incorporate the lunches into the schedules. In this regard, as described below, the schedules can be processed according to a “Lunch-Potential Fractional” process (stage 190a) followed by a “Lunch-Filled Fractional” process (stage 190b). Either after processing the schedules according to the Lunch Potential Fractional process, or if the set of schedules do not contain at least one lunch break in the schedule, the set of schedules can be processed according to a “Lunch-Filled Integer” process at stage 185.

The Lunch-Potential Fractional process considers only those sets of shift schedules that have an associated cost is equal to the optimal cost found in the Pre-Lunch Fractional process, and have an associated efficiency that equals the optimal efficiency found in the Shift-Efficiency Fractional process. The Lunch-Potential Fractional process also has an additional objective of considering lunch breaks when selecting a set of schedules. As previously indicated, lunch breaks are typically accounted for at this stage, as opposed to an earlier stage, to constrain the size of the problems solved at the previous stages of the method. Typically, shift scheduling instances have several thousand schedules that need to be considered and, as such, if lunches are accounted for at the beginning of the method, the number of possibilities considered can be on the order of 50-100 billion or more. To circumvent such issues, then, lunches are typically ignored in the first phases of the method and focus is instead drawn to identifying a set of cost-efficient, but “lunch less,” schedules that are highly likely to be members of the optimal set of schedules.

As discussed earlier, the method of embodiments of the present invention selects efficient schedules in the first stages with no consideration for the ease with which such schedules can be subsequently assigned lunch breaks. As will be appreciated, two solutions that appear identical in terms of efficiency and meeting all of the foregoing constraints may be very different when lunch breaks are inserted into the schedules.

For every schedule that is processed by the Shift-Efficiency Fractional process (stage 175b), the method of one advantageous embodiment calculates a lunch insertion index that measures the ease with which lunches can be inserted into the schedule. In other terms, the lunch insertion index measures the flexibility of a schedule to the insertion of a lunch at different times throughout the schedule. As will be appreciated by those skilled in the art, lunch breaks are more likely to be inserted into points of a schedule that have a low demand for workers. Those schedules with low demands for workers, then, will have a relatively high lunch insertion index. If a schedule shows little or no signs of low demand, however, then chances are that any lunch break insertion into the schedule will necessitate the addition of an extra schedule to cover demand during the original schedule's lunch break. In this case, the schedule will have a relatively low lunch insertion index.

For example, consider a schedule with only one shift that runs from 11 am to 2 pm. Then, assume that the demand for workers in the 11 am-2 pm period is as follows: five workers required from 11 am-12 pm, two workers required from 12 pm-1 pm, and five workers required from 1 pm-2 pm. In this case, since the demand for workers is less between 12 pm-1 pm, the potential exists to assign a lunch break to the shift under consideration in the time period between 12 pm and 1 pm. This potential, then, can be quantified by adding up the periods of less-than-maximum demand. To illustrate with the above example, the maximum demand in the 11 am-2pm period is five workers. In the 12 pm-1 pm period, the demand is only two workers, so there is a difference of three workers over that one hour period. To determine the lunch insertion index, the difference in demand is multiplied by the number of five-minute intervals (i.e., requirement intervals) over which the difference in demand holds true, i.e., 3×12=36, to arrive at the lunch insertion index for the shift over the 12 pm-1 pm period. For schedules with more than one shift, the lunch insertion index can be determined for the schedule by summing the lunch insertion index for each shift to arrive at the index for the schedule as a whole.

The Lunch-Potential Fractional process considers only those solutions selected from the Shift-Efficiency Fractional process. In operation, then, the Lunch-Potential Fractional process generally finds a set of schedules that maximize the lunch insertion index from amongst the set of schedules from in the Shift-Efficiency Fractional process. Whereas the Lunch-Potential Fractional process can be written in any of a number of different manners, in one embodiment the Lunch-Potential Fractional process can be written notationally as follows:

$$Max {Z}_{LPP} = {\sum }_{j = 1}^{n} {g}_{j} {y}_{j}$$

subject to the constraints of the Shift-Efficiency Fractional process, as well as the following constraint:

$${\sum }_{j = 1}^{n} {e}_{j} {y}_{j} \leq {Z}_{SEP}$$

Where:

gⱼ=“Lunch insertion index” of scheduled

Z_{SEP}=Objective value from the Shift-Efficiency Fractional process.

The set of schedules selected according to the Lunch-Potential Fractional process at stage 190a is then sent to the Lunch-Filled Fractional process at stage 190b, which attempts to further refine the set of schedules obtained by the Lunch-Potential Fractional process. As will be appreciated, the schedules output from the Lunch-Potential Fractional process contain lunch breaks. The Lunch-Filled Fractional process generally has the same configuration as the Pre-Lunch Fractional process, however, the Lunch-Filled Fractional process typically receives schedules that have lunch breaks taken into consideration. In this regard, the set of schedules from the Lunch-Filled Fractional process has lunch breaks assigned and meets all of the previously described user-defined constraints. As such, a further description of the Lunch-Filled Fractional process will not be given herein.

As will be appreciated, the set of schedules from the Lunch-Filled Fractional process may include non-integer schedules. For example, the solution may have 3.6 copies of schedule A and 4.7 copies schedule B in the solution. As such, the set of schedules from the Lunch-Filled Fractional process can be further processed by the Lunch-Filled Integer process at stage 185 to thereby select a set of integer schedules. As shown, the Lunch-Filled Integer process receives schedules from the Lunch-Filled Fractional process if lunches are present in the schedules or, alternatively, from the Shift-Efficiency Fractional process (stage 160) if no lunches exist in the schedule. The Lunch-Filled Integer process is similar to the Pre-Lunch Fractional process and the Lunch-Filled Fractional process except that the decision variables in the Lunch-Filled Integer process are integers. As such, the Lunch-Filled integer process can be represented notationally similar to the Pre-Lunch Fractional process, with the decision variables, yᵢ, representing integers instead of rational numbers

Once the Lunch-Filled Integer process has selected the set of integer schedules, the cost associated with the set of schedules (i.e., sum of each schedule in the optimum set of schedules) can be compared to the threshold cost, as shown at stage 195. As indicated above, by relating the cost associated with the set of integer schedules with the threshold cost, a quantitative guarantee of the quality of the set of integer schedules can be generated. If the set of integer schedules is within a predefined acceptable variation from the threshold cost, the set of integer schedules can be selected as the optimum set of schedules. If the integer schedules are not within the predefined acceptable variation from the threshold cost, however, the method can be repeated by selecting another set of integer schedules at stage 185. In this regard, as will be appreciated, a plurality of sets of integer schedules can be selected from the schedules output from the Shift-Efficiency Fractional process (stage 175) or the Lunch-Filled Fractional process (stage 180b). After the new set of integer schedules has been selected, the cost associated with the new set of integer schedules can be compared to the threshold cost to determine if the new set of integer schedules is within the predefined acceptable variation from the threshold cost. The method can therefore repeat with new sets of generated integer schedules until an integer set of schedules is generated that has an associated cost within the predefined acceptable variation from the threshold cost.

As will be appreciated, in some instances the acceptable variation can be set at such a low level that, after applying the business rules and constraints, no set of shift schedules has the requisite cost, or an undesirable amount of time is required to select a set of schedules within the acceptable variation. In such instances, the method can continue in any number of different manners. For example, a time limit can be defined such that after the first integer set of schedules has been selected, the method repeats by searching for sets of schedules with smaller variation from the threshold cost until the time limit has been exceeded, or until a set of schedules has been selected that has an associated cost within the predefined acceptable variation from the threshold cost, whichever is earlier.

Also, as indicated above, the threshold cost is typically the smallest cost associated with any set of schedules selected from either the schedules with valid start times (stage 115, 165) or the intermediate allowable schedules (stage 120, 160), and actually represents a lower bound of the cost associated with the least costly set of candidate schedules that satisfies all of the subsequently applied business rules and constraints. As such, it will also be appreciated that the threshold cost can be determined at any of a number of different points during operation of the method. For example, in an alternative embodiment, the threshold cost can be determined after incorporating lunches into the schedules (stage 145, 190). It will be noted, however, that as more business rules and constraints that are applied to the candidate schedules before determining the threshold cost, the threshold cost will typically increase as applying business rules or constraints to the remaining candidate schedules typically increases the cost of such schedules.

Embodiments of the present invention therefore provide improved systems, methods and computer program products for generating at least one shift schedule. Embodiments of the present invention are capable of generating at least one, and more typically, an optimum set of shift schedules based upon a quantitative measure of quality to thereby facilitate selecting an optimum set of schedules that has a desired level of quality. In this regard, embodiments of the present invention are capable of repeatedly selecting different sets of shift schedules until a set of shift schedules is found that has the desired level of quality, thereby providing increased control over the quality of the optimum set of shift schedules and the processing time required to select the optimum set of shift schedules.

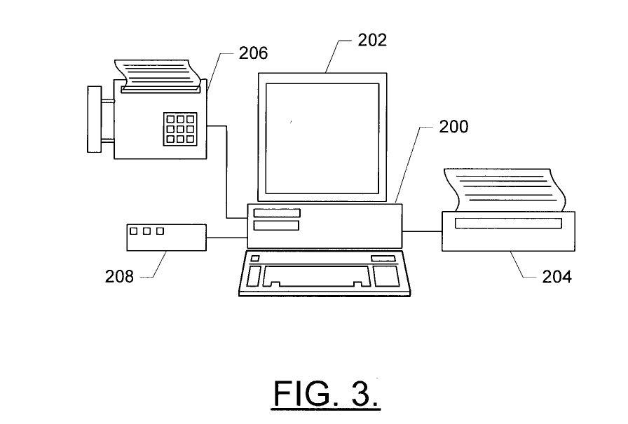

As shown in FIG. 3, the system of the present invention is typically embodied by a processing element and an associated memory device, both of which are commonly comprised by a computer 200 or the like. In this regard, as indicated above, the method of embodiments of the present invention can be performed by the processing element manipulating data stored by the memory device. The computer can include a display 202 for presenting information relative to performing embodiments of the present invention, including the various sets of schedules as determined according to embodiments of the present invention. To plot information relative to embodiments of the method of the present invention, the computer can further include a printer 204.

Also, the computer 200 can include a means for locally or remotely transferring the information relative to embodiments of the method of the present invention. For example, the computer can include a facsimile machine 206 for transmitting information to other facsimile machines, computers or the like. Additionally, or alternatively, the computer can include a modem 208 to transfer information to other computers or the like. Further, the computer can include an interface (not shown) to a network, such as a local area network (LAN), and/or a wide area network (WAN). For example, the computer can include an Ethernet Personal Computer Memory Card International Association (PCMCIA) card configured to transmit and receive information to and from a LAN, WAN or the like.

According to one aspect of the present invention, the system of the present invention generally operates under control of a computer program product. The computer program product for performing the methods of embodiments of the present invention includes a computer-readable storage medium, such as the non-volatile storage medium, and computer-readable program code portions, such as a series of computer instructions, embodied in the computer-readable storage medium. It should be understood that the computer-readable program code portions may include separate executable portions for performing distinct functions to accomplish methods of embodiments of the present invention. Additionally, or alternatively, one or more of the computer-readable program portions may include one or more executable portions for performing more than one function to thereby accomplish methods of embodiments of the present invention.

In this regard, FIGS. 1 and 2 are flowcharts of methods, systems and program products according to the invention. It will be understood that each block or step of the flowchart, and combinations of blocks in the flowchart, can be implemented by computer program instructions. These computer program instructions may be loaded onto a computer or other programmable apparatus to produce a machine, such that the instructions which execute on the computer or other programmable apparatus create means for implementing the functions specified in the flowchart block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the flowchart block(s) or step(s).

Accordingly, blocks or steps of the flowchart support combinations of means for performing the specified functions, combinations of steps for performing the specified functions and program instruction means for performing the specified functions. It will also be understood that each block or step of the flowchart, and combinations of blocks or steps in the flowchart, can be implemented by special purpose hardware-based computer systems which perform the specified functions or steps, or combinations of special purpose hardware and computer instructions.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method of generating at least one shift schedule comprising:
receiving scheduling data;
generating a plurality of candidate shift schedules based upon the scheduling data; and
selecting an optimum set of shift schedules based upon the plurality of candidate shift schedules and a quantitative measure of quality associated with the optimum set of shift schedules, wherein the quantitative measure of quality is based upon a threshold cost and a cost associated with the optimum set of shift schedules.

2. A method according to claim 1 further comprising processing the plurality of candidate shift schedules in accordance with at least one business rule before selecting an optimum set of shift schedules, wherein selecting an optimum set of shift schedules comprises selecting an optimum set of shift schedules based upon the processed plurality of candidate shift schedules and the quantitative measure of quality.

3. A method according to claim 2, wherein processing the plurality of candidate shift schedules comprises processing the plurality of candidate shift schedules in accordance with a back-to-back rule to identify any groups of part-time schedules that have an equivalent full-time schedule, and wherein selecting an optimum set of shift schedules comprises selecting an optimum set of shift schedules such that the set does not include a group of part-time schedules that has an equivalent full-time schedule.

4. A method according to claim 2, wherein processing the plurality of candidate shift schedules comprises processing the plurality of shift schedules in accordance with a maximum starts constraint to thereby select a plurality of schedules with valid starts such that the plurality of schedules with valid starts include at least one non-integer schedule, and such that each schedule with valid starts has a number of shift start times not exceeding a maximum number of start times, and wherein selecting an optimum set of shift schedules comprises selecting an optimum set of shift schedules based upon the plurality of schedules with valid starts and the quantitative measure of quality.

5. A method according to claim 4, wherein processing the plurality of candidate shift schedules further comprises processing the plurality of schedules with valid starts to select a plurality of efficient candidate schedules and thereafter find a plurality of integer schedules, and wherein selecting an optimum set of shift schedules comprises selecting an optimum set of shift schedules based upon the plurality of integer shift schedules and the quantitative measure of quality.

6. A method according to claim 2, wherein processing the plurality of candidate shift schedules comprises processing the plurality of candidate shift schedules in accordance with the scheduling data to select a plurality of intermediate shift schedules that includes at least one non-integer schedule, and wherein selecting an optimum set of shift schedules comprises selecting an optimum set of shift schedules based upon the plurality of intermediate shift schedules and the quantitative measure of quality.

7. A method according to claim 6, wherein processing the plurality of candidate shift schedules further comprises processing the plurality of intermediate shift schedules to select a plurality of efficient candidate schedules and thereafter find a plurality of integer schedules, and wherein selecting an optimum set of shift schedules comprises selecting an optimum set of shift schedules based upon the plurality of integer shift schedules and the quantitative measure of quality.

8. A method according to claim 2, wherein processing the plurality of candidate shift schedules comprises processing the plurality of candidate shift schedules to incorporate at least one lunch into the plurality of candidate shift schedules when the scheduling data defines at least one lunch, and wherein selecting an optimum set of shift schedules comprises selecting an optimum set of shift schedules based upon the plurality of candidate shift schedules including at least one incorporated lunch and the quantitative measure of quality.

9. A method according to claim 8, wherein processing the plurality of candidate shift schedules further comprises processing the plurality of candidate shift schedules to select a plurality of intermediate shift schedules when the plurality of candidate schedules are not subject to a maximum starts constraint, and wherein processing the plurality of candidate shift schedules to select a plurality of intermediate shift schedules occurs before processing the plurality of candidate shift schedules to incorporate at least one lunch.

10. A method according to claim 9, wherein processing the plurality of candidate shift schedules further comprises processing the plurality of candidate shift schedules in accordance with a maximum starts constraint to thereby select a plurality of schedules with valid starts when the plurality of candidate schedules are subject to a maximum starts constraint, and wherein processing the plurality of shift schedules to select a plurality of schedules with valid starts occurs before processing the plurality of candidate shift schedules to incorporate at least one lunch.

11. A method according to claim 8, wherein processing the plurality of candidate shift schedules to incorporate at least one lunch into the plurality of candidate shift schedules further comprises selecting a plurality of flexible candidate schedules based upon a flexibility to insertion of at least one lunch, wherein selecting a plurality of flexible candidate schedules occurs before processing the plurality of candidate shift schedules to incorporate at least one lunch, and wherein processing the plurality of candidate shift schedules to incorporate at least one lunch comprises processing the plurality of flexible candidate shift schedules to incorporate at least one lunch.

12. A method according to claim 2, wherein processing the plurality of candidate shift schedules comprises selecting a plurality of efficient candidate schedules, and wherein selecting an optimum set of shift schedules comprises selecting an optimum set of shift schedules based upon plurality of efficient candidate shift schedules.

13. A method according to claim 1 further comprising:
determining a threshold cost based upon the plurality of candidate shift schedules, wherein determining a threshold cost comprises determining a minimum cost associated with any set of candidate shift schedules capable of being selected in accordance with the scheduling data, and wherein the threshold cost comprises a lower bound cost associated with the selected optimum set of shift schedules.

14. A method according to claim 1, wherein selecting an optimum set of shift schedules comprises selecting an optimum set of shift schedules that has an associated cost within a predefined acceptable variation from the threshold cost.

15. A method according to claim 14, wherein selecting an optimum set of shift schedules comprises:
selecting a set of shift schedules in accordance with the scheduling data; and
comparing a cost associated with the set of shift schedules to the threshold cost, wherein selecting a set of shift schedules and comparing the cost comprise repeatedly selecting a set of shift schedules and repeatedly comparing the cost until an optimum set of shift schedules is selected that has an associated cost within a predefined acceptable variation from the threshold cost.

16. A system for generating at least one shift schedule comprising:
a processing element capable of receiving scheduling data, and thereafter generating a plurality of candidate shift schedules based upon the scheduling data, wherein the processing element is also capable of selecting an optimum set of shift schedules based upon the plurality of candidate shift schedules and a quantitative measure of quality associated with the optimum set of shift schedules, and wherein the quantitative measure of quality is based upon a threshold cost and a cost associated with the optimum set of shift schedules.

17. A system according to claim 16, wherein the processing element is further capable of processing the plurality of candidate shift schedules in accordance with at least one business rule before selecting the optimum set of shift schedules, and wherein the processing element is capable of selecting the optimum set of shift schedules based upon the processed plurality of candidate shift schedules and the quantitative measure of quality.

18. A system according to claim 17, wherein the processing element is capable of processing the plurality of candidate shift schedules in accordance with a back-to-back rule to identify any groups of part-time schedules that have an equivalent full-time schedule, and wherein the processing element is capable of selecting the optimum set of shift schedules such that the set does not include a group of part-time schedules that has an equivalent full-time schedule.

19. A system according to claim 17, wherein the processing element is capable of processing the plurality of shift schedules in accordance with a maximum starts constraint to thereby select a plurality of schedules with valid starts such that the plurality of schedules with valid starts include at least one non-integer schedule, and such that each schedule with valid starts has a number of shift start times not exceeding a maximum number of start times, and wherein the processing element is capable of selecting the optimum set of shift schedules based upon the plurality of schedules with valid starts and the quantitative measure of quality.

20. A system according to claim 19, wherein the processing element is capable of further processing the plurality of schedules with valid starts to select a plurality of efficient candidate schedules and thereafter find a plurality of integer schedules, and wherein the processing element is capable of selecting the optimum set of shift schedules based upon the plurality of integer shift schedules and the quantitative measure of quality.

21. A system according to claim 17, wherein the processing element is capable of processing the plurality of candidate shift schedules in accordance with the scheduling data to select a plurality of intermediate shift schedules that includes at least one non-integer schedule, and wherein the processing element is capable of selecting the optimum set of shift schedules based upon the plurality of intermediate shift schedules and the quantitative measure of quality.

22. A system according to claim 21, wherein the processing element is capable of further processing the plurality of intermediate shift schedules to select a plurality of efficient candidate schedules and thereafter find a plurality of integer schedules, and wherein the processing element is capable of selecting the optimum set of shift schedules based upon the plurality of integer shift schedules and the quantitative measure of quality.

23. A system according to claim 17, wherein the processing element is capable of processing the plurality of candidate shift schedules to incorporate at least one lunch into the plurality of candidate shift schedules when the scheduling data defines at least one lunch, and wherein the processing element is capable of selecting the optimum set of shift schedules based upon the plurality of candidate shift schedules including at least one incorporated lunch and the quantitative measure of quality.

24. A system according to claim 23, wherein the processing element is capable of further processing the plurality of candidate shift schedules to select a plurality of intermediate shift schedules when the plurality of candidate schedules are not subject to a maximum starts constraint, and wherein the processing element is capable of processing the plurality of candidate shift schedules to select the plurality of intermediate shift schedules before processing the plurality of candidate shift schedules to incorporate at least one lunch.

25. A system according to claim 24, wherein the processing element is capable of further processing the plurality of candidate shift schedules in accordance with a maximum starts constraint to thereby select a plurality of schedules with valid starts when the plurality of candidate schedules are subject to a maximum starts constraint, and wherein the processing element is capable of processing the plurality of shift schedules to select the plurality of schedules with valid starts before processing the plurality of candidate shift schedules to incorporate at least one lunch.

26. A system according to claim 23, wherein the processing element is capable of processing the plurality of candidate shift schedules to incorporate at least one lunch by further selecting a plurality of flexible candidate schedules based upon a flexibility to insertion of at least one lunch, wherein the processing element is capable of selecting the plurality of flexible candidate schedules before processing the plurality of candidate shift schedules to incorporate at least one lunch, and wherein the processing element is capable of processing the plurality of flexible candidate shift schedules to incorporate at least one lunch.

27. A system according to claim 17, wherein the processing element is capable of processing the plurality of candidate shift schedules to select a plurality of efficient candidate schedules, and wherein the processing element is capable of selecting an optimum set of shift schedules based upon plurality of efficient candidate shift schedules.

28. A system according to claim 16, wherein the processing element is also capable of determining a threshold cost based upon the plurality of candidate shift schedules, wherein the threshold cost comprises a minimum cost associated with any set of candidate shift schedules capable of being selected in accordance with the scheduling data, and wherein the threshold cost comprises a lower bound cost associated with the selected optimum set of shift schedules.

29. A system according to claim 16, wherein the processing element is capable of selecting the optimum set of shift schedules that has an associated cost within a predefined acceptable variation from the threshold cost.

30. A system according to claim 29, wherein the processing element is capable of selecting the optimum set of shift schedules by selecting a set of shift schedules in accordance with the scheduling data, and thereafter comparing a cost associated with the set of shift schedules to the threshold cost, and wherein the processing element is capable of repeatedly selecting a set of shift schedules and repeatedly comparing the cost until an optimum set of shift schedules is selected that has an associated cost within the predefined acceptable variation from the threshold cost.

31. A computer program product for generating at least one shift schedule, the computer program product comprising a computer-readable storage medium having computer-readable program code portions stored therein, the computer-readable program portions comprising:
a first executable portion for receiving scheduling data;
a second executable portion for generating a plurality of candidate shift schedules based upon the scheduling data; and
a third executable portion for selecting an optimum set of shift schedules based upon the plurality of candidate shift schedules and a quantitative measure of quality associated with the optimum set of shift schedules, wherein the quantitative measure of quality is based upon a threshold cost and a cost associated with the optimum set of shift schedules.

32. A computer program product according to claim 31 further comprising a fourth executable portion for processing the plurality of candidate shift schedules in accordance with at least one business rule before the third executable portion selects an optimum set of shift schedules, wherein the third executable portion selects an optimum set of shift schedules based upon the processed plurality of candidate shift schedules and the quantitative measure of quality.

33. A computer program product according to claim 32, wherein the fourth executable portion processes the plurality of candidate shift schedules in accordance with a back-to-back rule to identify any groups of part-time schedules that have an equivalent full-time schedule, and wherein the third executable portion selects an optimum set of shift schedules such that the set does not include a group of part-time schedules that has an equivalent full-time schedule.

34. A computer program product according to claim 32, wherein the fourth executable portion processes the plurality of shift schedules in accordance with a maximum starts constraint to thereby select a plurality of schedules with valid starts such that the plurality of schedules with valid starts include at least one non-integer schedule, and such that each schedule with valid starts has a number of shift start times not exceeding a maximum number of start times, and wherein the third executable portion selects an optimum set of shift schedules based upon the plurality of schedules with valid starts and the quantitative measure of quality.

35. A computer program product according to claim 34, wherein the fourth executable portion further processes the plurality of schedules with valid starts to select a plurality of efficient candidate schedules and thereafter find a plurality of integer schedules, and wherein the third executable portion selects an optimum set of shift schedules based upon the plurality of integer shift schedules and the quantitative measure of quality.

36. A computer program product according to claim 32, wherein the fourth executable portion processes the plurality of candidate shift schedules in accordance with the scheduling data to select a plurality of intermediate shift schedules that includes at least one non-integer schedule, and wherein the third executable portion selects an optimum set of shift schedules based upon the plurality of intermediate shift schedules and the quantitative measure of quality.

37. A computer program product according to claim 36, wherein the fourth executable portion further processes the plurality of intermediate shift schedules to select a plurality of efficient candidate schedules and thereafter find a plurality of integer schedules, and wherein the third executable portion selects an optimum set of shift schedules based upon the plurality of integer shift schedules and the quantitative measure of quality.

38. A computer program product according to claim 32, wherein the fourth executable portion processes the plurality of candidate shift schedules to incorporate at least one lunch into the plurality of candidate shift schedules when the scheduling data defines at least one lunch, and wherein the third executable portion selects an optimum set of shift schedules based upon the plurality of candidate shift schedules including at least one incorporated lunch and the quantitative measure of quality.

39. A computer program product according to claim 38, wherein the fourth executable portion further processes the plurality of candidate shift schedules to select a plurality of intermediate shift schedules when the plurality of candidate schedules are not subject to a maximum starts constraint, and wherein the fourth executable portion selects the plurality of intermediate shift schedules before processing the plurality of candidate shift schedules to incorporate at least one lunch.

40. A computer program product according to claim 39, wherein the fourth executable portion further processes the plurality of candidate shift schedules in accordance with a maximum starts constraint to thereby select a plurality of schedules with valid starts when the plurality of candidate schedules are subject to a maximum starts constraint, and wherein the fourth executable portion selects the plurality of schedules with valid starts before processing the plurality of candidate shift schedules to incorporate at least one lunch.

41. A computer program product according to claim 38, wherein the fourth executable portion processes the plurality of candidate shift schedules to incorporate at least one lunch by further selecting a plurality of flexible candidate schedules based upon a flexibility to insertion of at least one lunch, wherein the fourth executable portion selects the plurality of flexible candidate'schedules before processing the plurality of candidate shift schedules to incorporate at least one lunch, and wherein the fourth executable portion processes the plurality of flexible candidate shift schedules to incorporate at least one lunch.

42. A computer program product according to claim 32, wherein the fourth executable portion processes the plurality of candidate shift schedules to select a plurality of efficient candidate schedules, and wherein the third executable portion selects an optimum set of shift schedules based upon plurality of efficient candidate shift schedules.

43. A computer program product according to claim 31 further comprising a fourth executable portion for determining a threshold cost based upon the plurality of candidate shift schedules, wherein the threshold cost comprises a minimum cost associated with any set of candidate shift schedules capable of being selected in accordance with the scheduling data, and wherein the threshold cost comprises a lower bound cost associated with the selected optimum set of shift schedules.

44. A computer program product according to claim 31, wherein the third executable portion selects an optimum set of shift schedules that has an associated cost within a predefined acceptable variation from the threshold cost.

45. A computer program product according to claim 44, wherein the third executable portion selects an optimum set of shift schedules by selecting a set of shift schedules in accordance with the scheduling data, and thereafter comparing a cost associated with the set of shift schedules to the threshold cost, wherein the third executable portion repeatedly selects a set of shift schedules and repeatedly compares the cost until the third executable portion selects an optimum set of shift schedules that has an associated cost within a predefined acceptable variation from the threshold cost.
